(19) United States
(12) Patent Application Publication
(10) Pub. No.: US 2026/0368520 A1
(43) Pub. Date: Nov. 19, 2026

(54) MACHINE LEARNING DEVICE, SEMICONDUCTOR DEVICE, AND NON-TRANSITORY COMPUTER-READABLE RECORDING MEDIUM

(71) Applicant: ROHM Co., Ltd., Kyoto (JP)

(72) Inventors: Hiroki Ishibashi, Kyoto (JP); Kenji Hamachi, Kyoto (JP)

(73) Assignee: ROHM Co., Ltd., Kyoto (JP)

(21) Appl. No.: 19/650,358

(22) Filed: Apr. 17, 2026

(30) Foreign Application Priority Data
Apr. 24, 2025 (JP) 2025-072455
Sep. 18, 2025 (JP) 2025-154933

(51) Int. Cl. G06N 3/08; G06N 3/045

(52) U.S. Cl. CPC G06N 3/08; G06N 3/045

(57) ABSTRACT

A machine learning device includes a model holding part and a learning calculation part. The model holding part is configured to hold a machine learning model including an input layer, an output layer, and at least one intermediate layer disposed between the input layer and the output layer. The learning calculation part is configured to execute a learning process of updating a weight of the output layer in the machine learning model based on learning data. A coefficient of an update amount of the weight is capable of being set to a value smaller than 1.

### CROSS-REFERENCE TO RELATED APPLICATION

This application claims the priority benefit of Japan application serial no. 2025-072455, filed on Apr. 24, 2025, and Japan application serial no. 2025-154933, filed on Sep. 18, 2025. The entirety of the above-mentioned patent applications is hereby incorporated by reference herein and made a part of this specification.

### BACKGROUND

### Technical Field

The present disclosure relates to a machine learning device.

### Related Art

Conventionally, in the industrial field of factory equipment maintenance, applications of artificial intelligence (AI) to condition-based maintenance of mechanical systems have been progressing.
Patent Document 1 (International Patent Publication No. WO2019/035279) is an example of conventional art related to the above.

### BRIEF DESCRIPTION OF THE DRAWINGS

FIG. 1 is a diagram showing a configuration of a computer.

FIG. 2 is a block diagram showing a basic configuration of a machine learning device.

FIG. 3 is a diagram showing a configuration of a machine learning model.

FIG. 4 is a diagram showing a processing flow related to update of a weight β.

FIG. 5 is a diagram showing time-series data of normal data and abnormal data.

FIG. 6 is a diagram showing FFT processed data of normal data and abnormal data, respectively.

FIG. 7A is a diagram showing time-series data of learning data and transition of loss during learning in a simulation condition A.

FIG. 7B is a diagram showing chunk No. at the start of divergence in the simulation of each time under the simulation condition A.

FIG. 8 is a diagram comparing data of chunk No. (193 and 497) at the start of divergence and previous one chunk No. (192 and 496).

FIG. 9 is a diagram showing time-series data of learning data, transition of a forgetting rate during learning, and transition of loss during learning in a simulation condition B.

FIG. 10A is a diagram showing chunk No. at the start of divergence in the simulation of each time under the simulation condition B.

FIG. 10B is a diagram showing a maximum value of loss during learning and chunk No. thereof in the simulation of each time under the simulation condition B.

FIG. 11A is a diagram showing time-series data of learning data and transition of loss during learning in a simulation condition C.

FIG. 11B is a diagram showing chunk No. at the start of divergence in the simulation of each time under the simulation condition C.

FIG. 12 is a diagram showing time-series data of learning data, transition of the forgetting rate during learning, and transition of loss during learning in the simulation condition D.

FIG. 13A is a diagram showing chunk No. at the start of divergence in the simulation of each time under the simulation condition D.

FIG. 13B is a diagram showing the maximum value of loss during learning and chunk No. thereof in the simulation of each time under the simulation condition D.

FIG. 14 is a diagram showing time-series data of learning data, transition of the forgetting rate during learning, and transition of loss during learning in a simulation condition E.

FIG. 15A is a diagram showing chunk No. at the start of divergence in the simulation of each time under the simulation condition E.

FIG. 15B is a diagram showing the maximum value of loss during learning and chunk No. thereof in the simulation of each time under the simulation condition E.

FIG. 16 is a diagram showing input layer data (three data in upper part) and output layer data (lower part) used in the simulation (supervised learning).

FIG. 17A is a diagram showing a forgetting rate function under a simulation condition (3) FIG. 17B is a diagram showing a forgetting rate function under a simulation condition (3)′.

FIG. 17C is a diagram showing a forgetting rate function under a simulation condition (5).

FIG. 17D is a diagram showing a forgetting rate function under a simulation condition (5)′.

FIG. 18 is a diagram showing results of errors calculated under seven conditions of simulation conditions (1) to (5)′.

FIG. 19 is a graph showing a relationship between a true value (horizontal axis) and a difference between the true value and a value after Bfloat16 conversion.

FIG. 20 is a graph showing a relationship between a true value (horizontal axis) and an error percentage upon converting the true value to Bfloat16.

FIG. 21 is a graph showing an amount of information (percentage) lost after Bfloat16 conversion from the true value.

FIG. 22 is a graph showing an example of a forgetting rate function.

FIG. 23 is a diagram showing an example of simulation results of learning using a forgetting rate function.

### DETAILED DESCRIPTION

### <Regarding Computer>

First, a computer 100 that functions as a machine learning device 6 according to the present disclosure will be described. Next, a basic configuration of the machine learning device 6 will be described. Thereafter, characteristic portions of the machine learning device 6 will be described in detail.

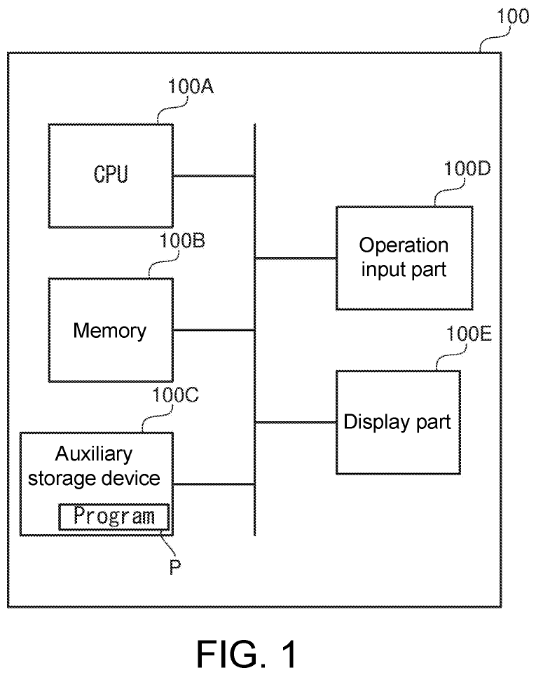

FIG. 1 is a diagram showing a configuration of the computer 100. The computer 100 functions as the machine learning device 6 (to be described later). The computer 100 is, for example, a personal computer (PC).

The computer 100 includes a central processing unit (CPU) 100A, a memory 100B, an auxiliary storage device 100C, an operation input part 100D, and a display part 100E.

The CPU 100A has a control device and a calculation device (both not shown). The control device interprets program commands and controls each part of the computer 100. The calculation device performs a calculation process.

The memory 100B is a semiconductor storage device configured to temporarily store programs or data. Information stored in the memory 100B is erased upon power-off of the computer 100.

The auxiliary storage device 100C is configured by a hard disk drive (HDD) or a solid state drive (SSD), and stores programs or data. The programs stored in the auxiliary storage device 100C are loaded into the memory 100B. The CPU 100A executes the programs loaded into the memory 100B.

Herein, a simulation program P is stored in the auxiliary storage device 100C. The simulation program P is a program for causing the computer 100 to function as the machine learning device 6 (to be described later). Details about the machine learning device 6 will be described later.

The operation input part 100D is configured by a keyboard or a mouse, and is a device configured to provide an operation input to the computer 100. Information inputted from the operation input part 100D is sent to the memory 100B.

The display part 100E is configured by, for example, a liquid crystal display, and converts information acquired from the memory 100B into images and outputs the images.

### <Regarding Basic Configuration of Machine Learning Device>

Next, the basic configuration of the machine learning device 6 will be described. The machine learning device 6 is realized by, for example, the computer 100 described above. The machine learning device 6 may be configured by a micro controller unit (MCU). In that case, the MCU is configured as a semiconductor device in which the machine learning device 6 is integrated. The machine learning device 6 as a semiconductor device is incorporated into a predetermined mechanical system (such as a motor device) and controls the mechanical system. In addition, the machine learning device 6 is capable of executing machine learning using various data of the mechanical system as input data, along with controlling the mechanical system.

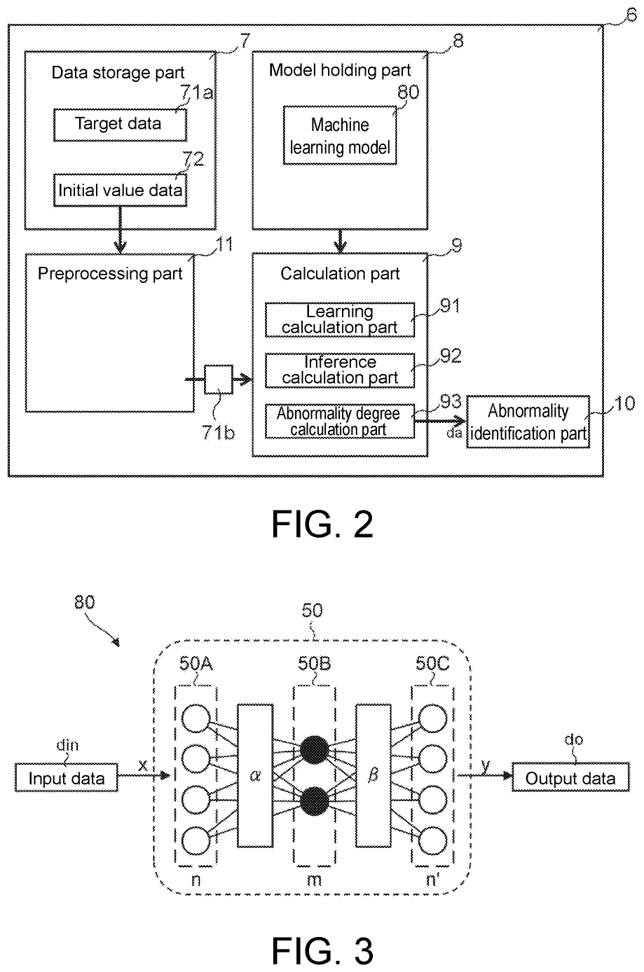

FIG. 2 is a block diagram showing the basic configuration of the machine learning device 6. As shown in FIG. 2, the machine learning device 6 includes a data storage part 7, a model holding part 8, a calculation part 9, an abnormality identification part 10, and a preprocessing part 11.

The data storage part 7 stores target data 71a and initial value data 72. The target data 71a is time-series data outputted from, for example, a mechanical system. The initial value data 72 includes initial values of various parameters used in a machine learning model 80 (to be described later).

The preprocessing part 11 performs a predetermined preprocess on the target data 71a to generate processed data 71b, specifically as described below.

The preprocessing part 11 performs a feature extraction process of extracting features of the target data 71a. For example, fast Fourier transform (FFT) may be adopted for the feature extraction process. The FFT process is a type of frequency analysis process.

The model holding part 8 holds a machine learning model 80. The machine learning model 80 is a machine learning model capable of learning and inferencing according to input data din. The target data 71a itself or the processed data 71b is inputted to the machine learning model 80 as the input data din. Details of the machine learning model 80 will be described later.

The calculation part 9 calculates a calculation result 30 using the input data din (corresponding to the processed data 71b) and the machine learning model 80. The calculation result 30 includes output data do and an abnormality degree da, which will be described later. The calculation part 9 will be specifically described as follows.

The calculation part 9 includes a learning calculation part 91, an inference calculation part 92, and an abnormality degree calculation part 93. The learning calculation part 91 performs learning using the machine learning model 80, the input data din, and the initial value data 72. Such learning may be either supervised learning or unsupervised learning.

The inference calculation part 92 performs inference using the machine learning model 80, the input data din, and the initial value data 72 to generate the output data do. The inference may be performed during the learning performed by the learning calculation part 91 and after completion of the learning.

The abnormality degree calculation part 93 calculates an abnormality degree da using an inference result obtained by the inference calculation part 92. The abnormality degree calculation part 93 transmits the calculated abnormality degree da to the abnormality identification part 10.

The abnormality degree da is a numerical value indicating a degree of abnormality present in the output data do. For example, an input-output error in the case of using unsupervised learning may be adopted as the abnormality degree da. The input-output error is an error between a value included in an input layer 50A (=input data din) and a value included in an output layer 50C(=output data do) in the case of inputting the input data din to the machine learning model 80 to execute inference. The input-output error is calculated according to a loss function (to be described later).

The abnormality identification part 10 receives the abnormality degree da from the abnormality degree calculation part 93 and identifies abnormality of the target data 71a (presence or absence of an abnormality, degree of the abnormality, etc.). For example, the abnormality identification part 10 compares the abnormality degree da with a predetermined abnormality determination threshold. In the case of performing supervised learning, the abnormality degree calculation part and the abnormality identification part may sometimes be omitted.

As described above, in the case of causing the computer 100 to function as the machine learning device 6, the abnormality identification part 10 outputs an identification result to the display part 100E. The identification result may be presence or absence of abnormality in the target data 71a, or a degree of abnormality in the target data 71a.

Next, the machine learning model 80 will be described in detail. FIG. 3 is a diagram showing a configuration of the machine learning model 80. The machine learning model 80 is an inference model capable of learning using predetermined learning data. As shown in FIG. 3, the machine learning model 80 includes a three-layered neural network 50.

The three-layered neural network 50 is an AI model having an input layer 50A, a hidden layer 50B, and an output layer 50C. The hidden layer 50B is also referred to as an intermediate layer. Generally, in the three-layered neural network 50, for n-dimensional input data x∈R^{k×n} of a batch size k, an n′-dimensional inference result y∈R^{k×n′} is obtained as y=G(x·α+b)β. Herein, α∈R^{n×m} is a weight that connects the input layer 50A and the hidden layer 50B. β∈R^{m×n′} is a weight that connects the hidden layer 50B and the output layer 50C. In addition, b∈R^{k×m} is a bias of the hidden layer 50B. G is an activation function of the hidden layer 50B. As the activation function, for example, Sigmoid or ReLU may be used.

The three-layered neural network 50 adopts an algorithm capable of learning sequentially with an arbitrary batch size. In the case where i-th learning data {xi∈R^{ki×n}, ti∈R^{ki×n′}} of a batch size ki, it is necessary to obtain Bi that minimizes an error shown by Equation (1) below.

$$‖ [ \begin{matrix}{H}_{0} \\ ⋮ \\ {H}_{i}\end{matrix} ] {β}_{i} - [ \begin{matrix}{t}_{0} \\ ⋮ \\ {t}_{i}\end{matrix} ] ‖ \qquad ( 1 )$$

The i-th hidden layer matrix Hᵢ=G(xᵢ·α+b). In addition, t is teacher data corresponding to the inference result y.

The optimized weight βᵢ₊₁ is calculated according to Equation (2) below.

βᵢ₊₁=βᵢ+(1/F)²*Pᵢ₊₁Hᵢ₊₁^{T}(tᵢ₊₁−Hᵢ₊₁βᵢ)Pᵢ₊₁=(Pᵢ⁻¹+Hᵢ₊₁^{T}Hᵢ₊₁)⁻¹=Pᵢ−PᵢHᵢ₊₁^{T}(I+Hᵢ₊₁PᵢHᵢ₊₁^{T})⁻¹Hᵢ₊₁Pᵢ (2)

The learning algorithm is as follows.
(A) Values of a weight α and a bias b are initialized by random numbers. In addition, the initial value β₀ of the weight β is determined by random numbers. (In the simulation examples to be described later, the bias b is set as a zero matrix.)
(B) H₀ for x₀ is calculated. P₀ is calculated according to P₀=(H₀^{T}H₀)⁻¹. P₀ (initial value of P) may be determined by random numbers.
(C) Each time the (i+1)th learning data of the batch size kᵢ₊₁ is obtained, βᵢ₊₁ is sequentially calculated based on Equation (2).

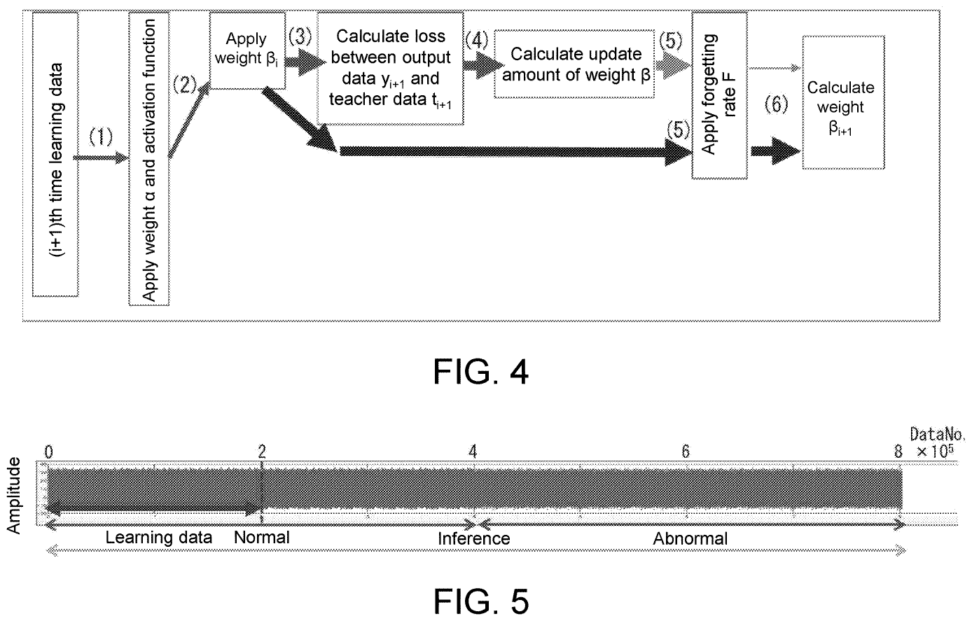

The update of βᵢ₊₁ will be described according to FIG. 4. Upon obtaining the (i+1)th time learning data, the (i+1)th hidden layer matrix Hᵢ₊₁ is calculated by applying the weight α and the activation function in (1) in FIG. 4. Then, the (i+1)th time output data yᵢ₊₁ is calculated by applying the weight βᵢ learned up to the i-th time in (2), and a loss (error) between the output data yᵢ₊₁ and the teacher data tᵢ₊₁ is calculated in (3). The loss corresponds to tᵢ₊₁−Hᵢ₊₁βᵢ in Equation (2).

Then, an update amount of the weight β is calculated in (4). The update amount corresponds to Pᵢ₊₁H^{T}ᵢ₊₁(tᵢ₊₁−Hᵢ₊₁βᵢ) in Equation (2). Then, the forgetting rate F is applied in (5). As expressed in Equation (2), the action of the forgetting rate F is performed by the action of a coefficient expressed by (1/F)². The greater the value of the forgetting rate F is, the smaller the value of the coefficient (1/F)² becomes, the smaller the update amount of the weight β becomes, and the lower the degree of forgetting past learning results becomes. Then, βᵢ₊₁ is calculated in (6), and the weight β is updated.

The computational bottleneck in Equation (2) above is (I+Hᵢ₊₁Hᵢ₊₁^{T})⁻¹, but since the matrix size of (I+Hᵢ₊₁PᵢHᵢ₊₁) is k×k, in the case of k=1, the inverse matrix operation can be replaced with a reciprocal operation. Therefore, by fixing the batch size to k=1, calculation becomes easy even with a calculation device at the level of a microcontroller.

In addition, the machine learning model 80 may perform learning using an autoencoder. The autoencoder uses input data directly as teacher data, and learns to be capable of reconstructing the input data as an inference result. That is, in the above description, learning is performed with t=x. Since the autoencoder does not require creating teacher data separately, it becomes a type of unsupervised learning algorithm. In addition, by configuring the number of nodes in the hidden layer to be smaller than the number of nodes in the input layer and the output layer, the hidden layer matrix can be regarded as a dimensional compression format of the input data in the case where the error between the input data and the inference result converges. That is, the encoding result of the input data x is H=G(x·α+b), and the decoding result of H is obtained as y=H·β.

<Regarding Abnormality Degree da>

Next, the abnormality degree da will be described in detail. The output data do is data of an inference result obtained as a result of inputting the input data din to the machine learning model 80 and performing inference. The input-output error is calculated according to a loss function based on the input data din and the output data do.

That is, the abnormality degree da, which is the input-output error, represents an error between the target data 71a (=input data din) and an inference result (output data do) based on the target data 71a. In other words, the abnormality degree da is an error between actual target data 71a and inferred computational target data 71a (=output data do). From this reason, it can be said that the abnormality degree da suggests abnormality possessed by the target data 71a. The calculation of the abnormality degree da is specifically as follows.

Individual input values included in the input data din are defined as input values x. In addition, individual output values (individual values of inference results) included in the output data do are defined as output values y. For example, Mean Absolute Error (MAE), Mean Squared Error (MSE), etc. may be adopted as the loss function for calculating the input-output error. In the case where the loss function is MAE, the loss function L is expressed as Equation (3) below.

$$L ( y , x ) = \frac{1}{n ′} \sum \vert y - x \vert \qquad ( 3 )$$

In addition, in the case where the loss function is MSE, the loss function L is expressed as Equation (4) below.

$$L ( y , x ) = \frac{1}{n ′} \sum {\vert y - x \vert}^{2} \qquad ( 4 )$$

By calculating the abnormality degree da as described above, it is possible to determine whether abnormal values are included in the input data din, and further whether an abnormality has occurred in the mechanical system or the like that implements the machine learning device 6.

### <Regarding Setting of Forgetting Rate>

During learning of a neural network, the weight β from the hidden layer to the output layer may diverge, and AI prediction may not be performed. As conventional countermeasures against divergence, adjustments are required, such as reducing the number of nodes of the hidden layer, reducing the number of learning data, or changing the activation function. In the sequential learning model described above, the weight β is updated by taking the sum of the weight β of the previous time and the update amount of β based on the learning result of the current time. At this time, by setting the forgetting rate F to 1 or less, the weighting of the update amount of the weight β can be made heavier, enabling efficient learning. However, in that case, the weight β may become prone to divergence.

Therefore, in the present disclosure, by setting the forgetting rate F to a value greater than 1 (that is, setting the coefficient of the update amount of the weight β to a value smaller than 1), the weighting of the update amount of the weight β is reduced, and divergence of the weight β is suppressed. Accordingly, learning becomes possible without taking the conventional countermeasures against divergence as described above. For example, it becomes possible to use learning data, learning conditions, and AI settings that could not converge even with learning in the conventional art. In addition, the degree of freedom is increased for other settings (increasing the number of nodes of the hidden layer, increasing learning data, changing the activation function, etc.) that would be prone to divergence in the conventional art, and prediction accuracy of the neural network can be improved.

In the present disclosure, the coefficient of the update amount of the weight β is not limited to, for example, the power of (1/F) being squaring (it may be to the first power). In addition, A may be called a learning rate, and for example, the coefficient of the update amount of the weight β may be set to (A)², and the value of A may be adjusted. In any case, the coefficient of the update amount of the weight β indicates the degree of forgetting in learning.

### <First Simulation Study>

Herein, the content of a simulation of learning by an autoencoder (unsupervised learning) implemented using the above computer 100 (machine learning device 6) will be described. As an example, a target for which analysis in the frequency domain is effective, such as a motor abnormality, is assumed. Herein, data was created in-house to make the effects of the present disclosure easy to understand.

With x as time, normal data and abnormal data were respectively set as follows.

### Normal Data

y=3 sin(220*2π*x)+14 sin(120*2π*x)+5 sin(60*2π*x)+2 sin(30*2π*x)+2.5 sin(20*2π*x)+10

### Abnormal Data

y=7 sin(220*2π*x)+10 sin(120*2π*x)+5 sin(60*2π*x)+2 sin(30*2π*x)+2.5 sin(20*2π*x)+10

That is, both the normal data and the abnormal data were composite waves of 220, 120, 60, 30, 20 Hz+DC component, and the amplitude values of 220 Hz and 120 Hz were different between the normal data and the abnormal data.

In addition, to provide variation in both the normal data and the abnormal data, for each chunk (401 data)
high frequency random sine wave 0.25 sin (1000*rand*2π*x)
low frequency random sine wave 0.25 sin (25*rand*2π*x)
were synthesized 500 each. (Chunks will be described later.)

A total of 80200 data were acquired at a sampling frequency of 200 Hz, and FFT process was performed on the acquired data in units of 401 data each. 401 data correspond to 1 chunk. A chunk is a unit indicating one block of data to be inputted to the machine learning model in learning of one time. In this case, FFT process was performed on 80200/401=2000 chunks. Since the data after FFT is converted to a single-sided amplitude spectrum, the data amount is reduced to approximately half. Therefore, the data amount per chunk becomes 201 data, and the total data amount is 402000 data. 500 chunks of the data after FFT (single-sided amplitude spectrum) were used as learning data. There were a total of 2000 chunks consisting of 1000 chunks of normal data and 1000 chunks of abnormal data, and 500 chunks out of the 1000 chunks of normal data were used as learning data.

FIG. 5 is a graph showing time-series data of a total of 80200 data (normal data in the first half+abnormal data in the second half), where the horizontal axis represents data No. and the vertical axis represents amplitude value. The learning data range is data No. 1 to 200500 (the first ¼ of all data) in the time-series data, which corresponds to chunk No. 1 to 500. As shown in FIG. 5, inference is performed over all data.

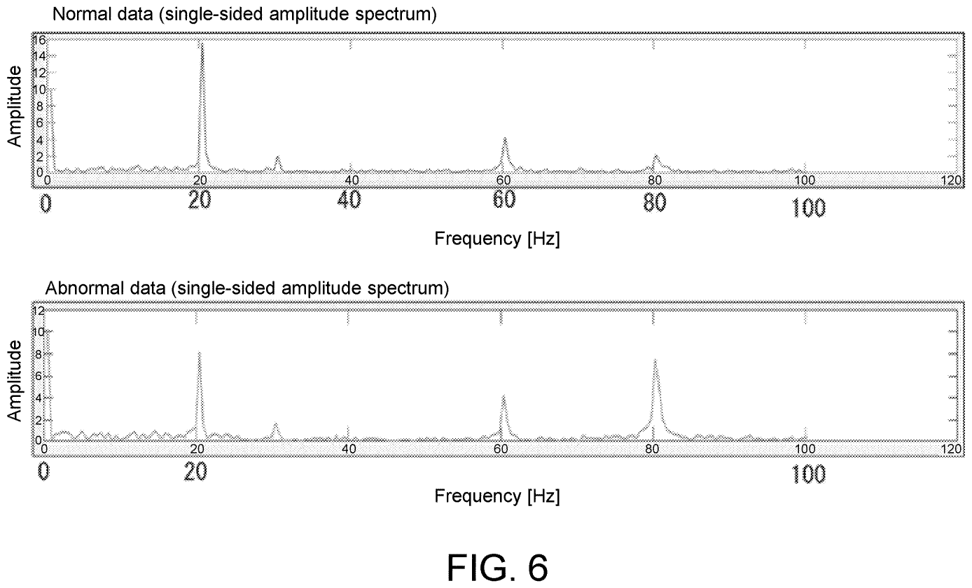

In addition, the upper part of FIG. 6 shows data after FFT process of normal data, and the lower part of FIG. 6 shows data after FFT process of abnormal data.

The results of learning simulation performed using the learning data as described above will be described below. In each simulation condition below, the following are common conditions.

### Common Conditions:

Number of hidden layer nodes: 50
Number of repeated learning iterations: 4
Activation function: ReLU
Loss function: MSE
Seed value: 6

The repeated learning is to return to learning at the initial chunk No. 1 after learning of chunk No. 1 to 500 and perform learning, and since the number of repeated learning iterations is 4 in the above, learning of chunk No. 1 to 500 is performed a total of 5 times (=1+4).

In addition, the seed value is a random number for determining the weight α. In the above, the value of the weight α determined based on the seed value being 6 is common for each simulation condition.

### <<Simulation Condition A>>

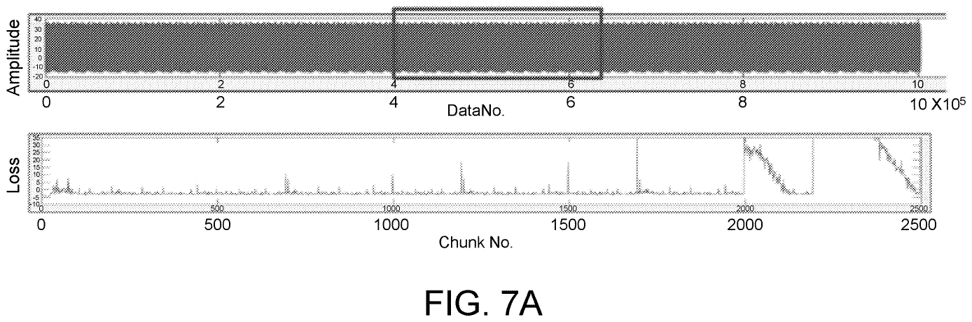

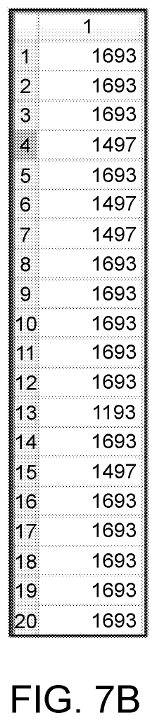

Herein, in addition to the above common conditions, a simulation was performed with a computational precision of “double” and a forgetting rate F of 0.92. FIG. 7A shows, in the upper part, time-series data of learning data for 4 repeated learning iterations under the simulation condition A, and shows, in the lower part, the transition of loss during learning for 4 repeated learning iterations. In the upper part of FIG. 7A, the horizontal axis is data No., and in the lower part of FIG. 7A, the horizontal axis is chunk No. (chunk No. 1 to 2500 (=500×5) for 4 repeated learning iterations). In addition, in the lower part of FIG. 7A, the vertical axis shows loss logarithmically.

Herein, as an empirical rule, when the loss exceeds 10\hat{ }5, AI prediction becomes quite poor and the weight β becomes prone to divergence, so taking a margin, it was determined that divergence occurred when exceeding 10\hat{ }10. As shown in the lower part of FIG. 7A, at chunk No. 1193, that is, at chunk No. 193 (=1193-500×2) in the learning data of No. 1 to 500, the loss exceeds 10\hat{ }10, and divergence has started. Since the forgetting rate F of 0.92 is a low forgetting rate, the weighting of the update amount of the weight β becomes large, and it can be said that the weight β is prone to divergence.

The simulation for learning of 4 repeated learning iterations was conducted for a total of 20 times, and the chunk No. when the loss during learning exceeded 10\hat{ }10 was confirmed to determine whether there was regularity in the chunk No. at the start of divergence. In the simulation of 20 times, the initial value of the weight β and the initial value of P in Equation (2) above were determined by random numbers for each time of simulation to perform learning. FIG. 7B shows the chunk No. at the start of divergence in the simulation of each time among the 20 times. Divergence was confirmed in all 20 times out of the 20 times. The chunk No. at the start of divergence is any of 1193, 1497, or 1693. That is, in terms of the learning data of chunk No. 1 to 500, divergence starts at chunk No. 193 and 497.

As described above, divergence was confirmed in all 20 times out of the 20 times, and it was confirmed that there was regularity in the chunk No. at the start of divergence. However, the reason why the update amount of the weight β becomes large and divergence occurs was expected to be due to a large difference in amplitude spectra between the previous one learning chunk and the chunk to be learned, so the following comparison was performed. That is, data were compared between the chunk No. (193 and 497) at the start of divergence and the previous one chunk No. (192 and 496).

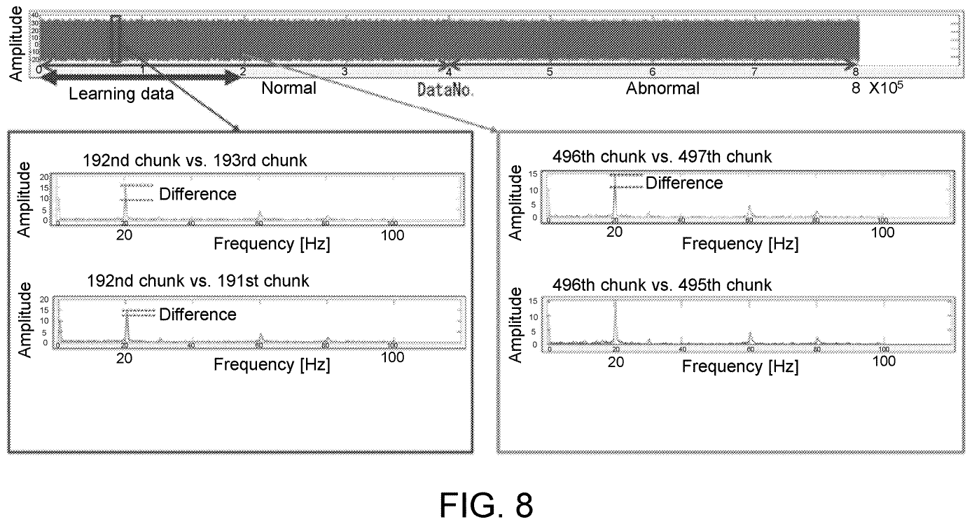

FIG. 8 shows the above comparison results. The amplitude value in the 20 Hz frequency band at chunk No. 193 at the start of divergence is significantly lower compared to the previous one chunk No. 192, and the amplitude value in the 20 Hz frequency band at chunk No. 497 at the start of divergence is significantly lower compared to the previous one chunk No. 496. The amplitude value in the 20 Hz frequency band at chunk No. 192 does not exhibit a large difference compared to the previous one chunk No. 191, and the amplitude value in the 20 Hz frequency band at chunk No. 496 does not exhibit a large difference compared to the previous one chunk No. 495. Therefore, it was determined that since the difference in amplitude values in the 20 Hz frequency band became large between the chunk No. at the start of divergence and the previous one chunk No., the update amount of the weight β became large, leading to divergence.

### <<Simulation Condition B>>

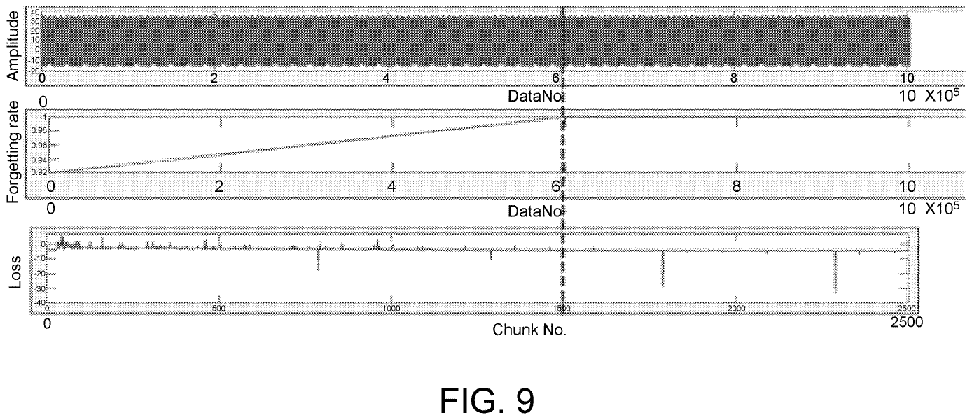

Herein, in addition to the above common conditions, a simulation was performed with a computational precision of “double” and a forgetting rate F that was linearly increased from 0.92 to 1.00 until the second repeated learning iteration. FIG. 9 shows, in the upper part, time-series data of learning data for 4 repeated learning iterations under the simulation condition B, shows, in the middle part, the transition of the forgetting rate during learning for 4 repeated learning iterations, and shows, in the lower part, the transition of loss during learning for 4 repeated learning iterations. In this manner, the loss does not exceed 10\hat{ }10, and divergence does not occur.

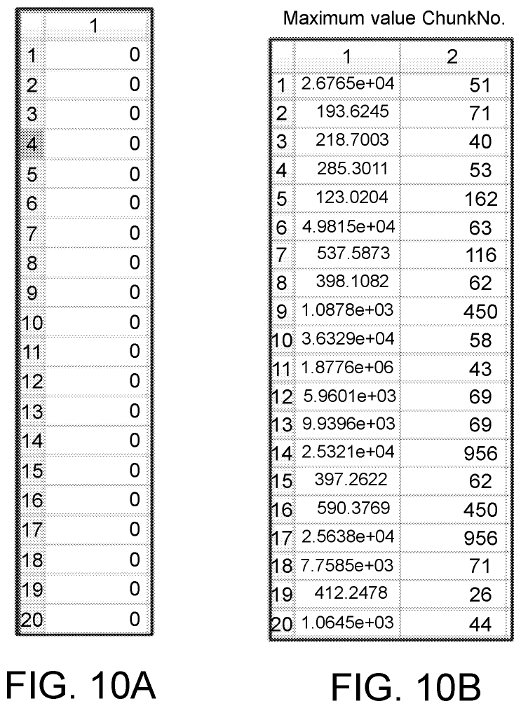

FIG. 10A shows the chunk No. at the start of divergence in each time of simulation in the case of performing a simulation for 4 repeated learning iterations for a total of 20 times, and it was confirmed that divergence does not occur in any of the 20 times (chunk No. 0 indicates that divergence does not occur). In addition, FIG. 10B shows the maximum value of loss during learning and the chunk No. thereof, in each time of simulation in the case of performing a simulation for 4 repeated learning iterations for a total of 20 times. The maximum value of loss occurred within 1000 chunks (within the second learning iteration) in all of the 20 times. In this manner, it can be understood that divergence can be suppressed by increasing the forgetting rate F to 1.00.

### <<Simulation Condition C>

Herein, in addition to the above common conditions, a simulation was performed with a computational precision of Bfloat16 and a forgetting rate F of 1.00. In the case of learning with Bfloat16, which is one of the floating point representation formats, learning accuracy is worse than “double” and divergence is prone to occur.

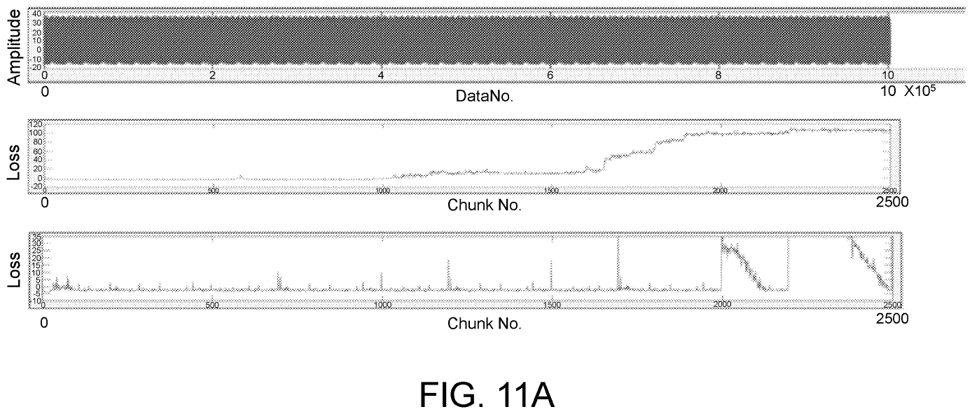

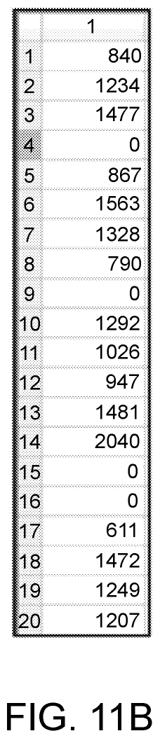

FIG. 11A shows, in the upper part, time-series data of learning data for 4 repeated learning iterations under the simulation condition C, and shows, in the middle part, the transition of loss during learning for 4 repeated learning iterations under the simulation condition C. The lower part of FIG. 11A shows, as a comparison, the transition of loss during learning for 4 repeated learning iterations with the computational precision in the simulation A (computational precision: double). In this manner, in the case of Bfloat16, loss gradually increases, leading to divergence. Since sections with large differences between learning iterations come periodically in repeated learning, loss becomes large each time such sections come, leading to divergence.

FIG. 11B shows the chunk No. at the start of divergence in the case of performing a simulation for 4 repeated learning iterations for a total of 20 times. In this manner, it was confirmed that divergence occurred in 16 times out of the 20 times, but the chunk No. at the start of divergence was different for each of the 16 times, and the tendency differs from the case of “double”.

### <<Simulation Condition D>>

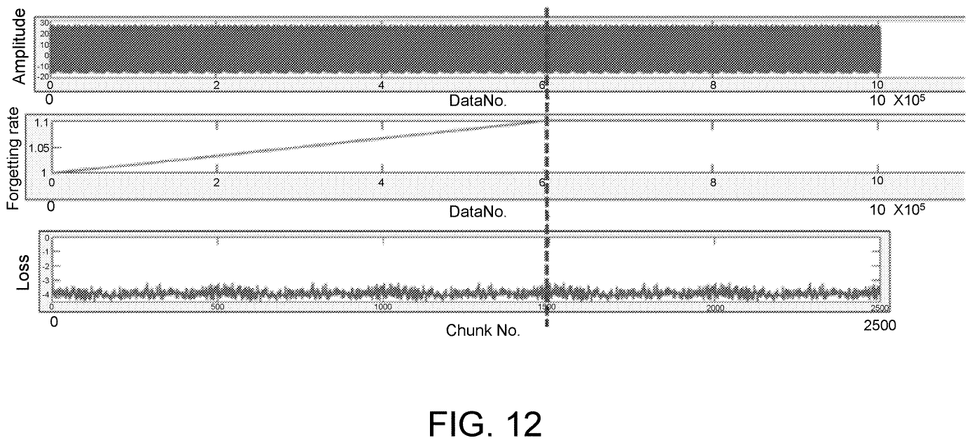

Herein, in addition to the above common conditions, a simulation was performed with a computational precision of Bfloat16 and a forgetting rate F that was linearly increased from 1.00 to 1.10 until the second repeated learning iteration. FIG. 12 shows, in the upper part, time-series data of learning data for 4 repeated learning iterations under the simulation condition D, shows, in the middle part, the transition of the forgetting rate during learning for 4 repeated learning iterations, and shows, in the lower part, the transition of loss during learning for 4 repeated learning iterations. In this manner, loss does not exceed 10\hat{ }10, and divergence does not occur.

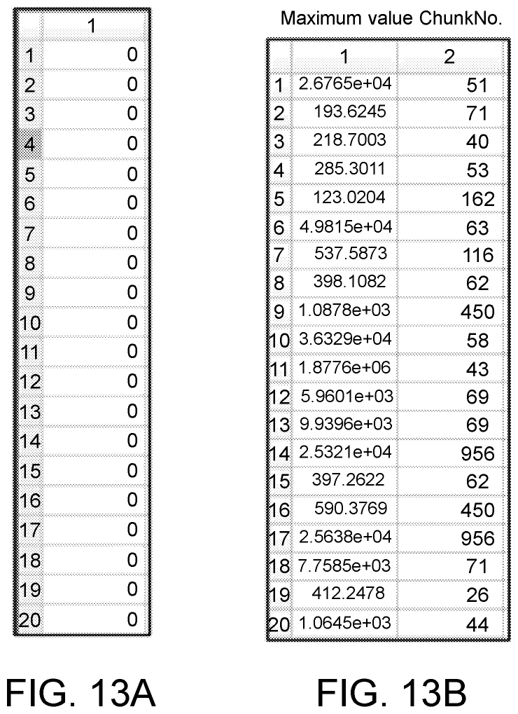

FIG. 13A shows the chunk No. at the start of divergence in each time of simulation in the case of performing a simulation for 4 repeated learning iterations for a total of 20 times, and it was confirmed that divergence does not occur in any of the 20 times (chunk No. 0 indicates that divergence does not occur). In addition, FIG. 13B shows the maximum value of loss during learning and the chunk No. thereof. The maximum value of loss occurred within 1000 chunks (within the second learning iteration) in all of the 20 times. In this manner, it can be understood that divergence can be suppressed by increasing the forgetting rate F to 1.10 (a value greater than 1.00). That is, even with a computational precision such as Bfloat16 with which divergence is prone to occur, divergence is suppressed by setting the coefficient of the update amount of the weight β to a value smaller than 1.00.

### <<Simulation Condition E>

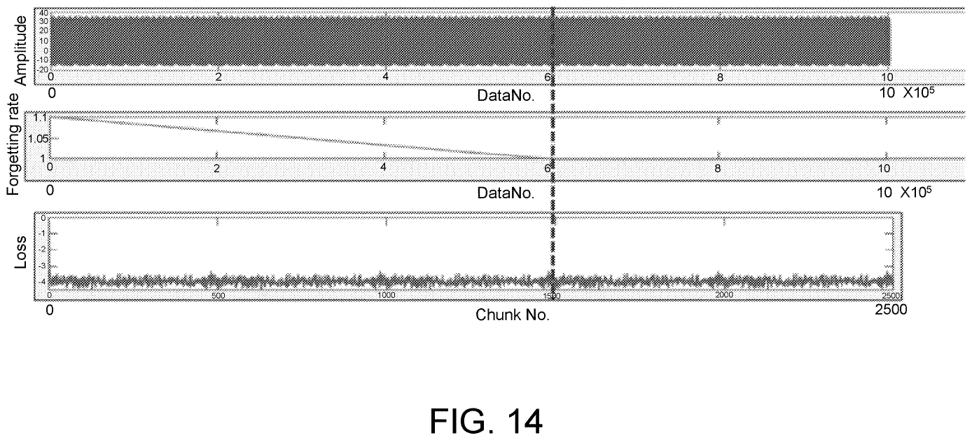

Herein, in addition to the above common conditions, a simulation was performed with a computational precision of Bfloat16 and a forgetting rate F that was linearly decreased from 1.10 to 1.00 until the second repeated learning iteration. FIG. 14 shows, in the upper part, time-series data of learning data for 4 repeated learning iterations under the simulation condition E, shows, in the middle part, the transition of the forgetting rate during learning for 4 repeated learning iterations, and shows, in the lower part, the transition of loss during learning for 4 repeated learning iterations. In this manner, loss does not exceed 10\hat{ }10, and divergence does not occur.

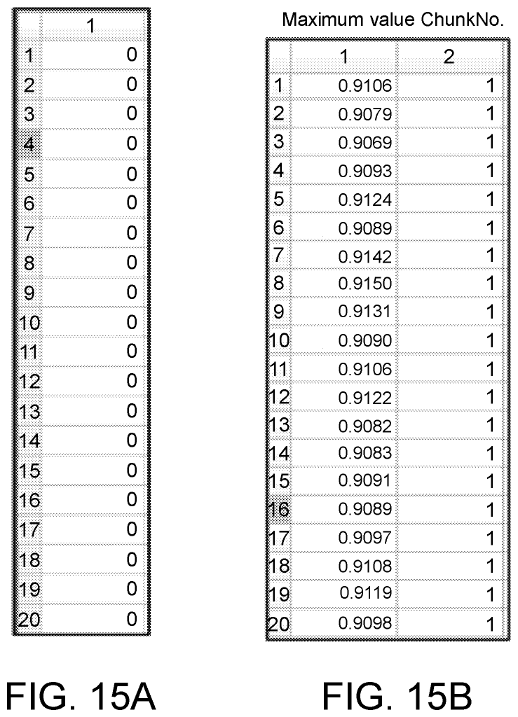

FIG. 15A shows the chunk No. at the start of divergence in each time of simulation in the case of performing a simulation for 4 repeated learning iterations for a total of 20 times, and it was confirmed that divergence does not occur in any of the 20 times (chunk No. 0 indicates that divergence does not occur). In addition, FIG. 15B shows the maximum value of loss during learning and the chunk No. thereof. The maximum value of loss occurred at the first chunk in all of the 20 times. In this manner, it can be understood that divergence can be suppressed by decreasing the forgetting rate F from 1.10 (a value greater than 1.00). That is, even with a computational precision such as Bfloat16 with which divergence is prone to occur, divergence is suppressed by setting the coefficient of the update amount of the weight β to a value smaller than 1.00.

### <Second Simulation Study>

Herein, the content of a simulation of learning by supervised learning implemented using the above computer 100 (machine learning device 6) will be described.

The input layer data of the machine learning model was data (9 data) represented by the following 3×3 matrix.

$$( \begin{matrix}{a}_{1} & {b}_{1} & {c}_{1} \\ {a}_{2} & {b}_{2} & {c}_{2} \\ {a}_{3} & {b}_{3} & {c}_{3}\end{matrix} )$$

(aₖ: input layer first column data, bk: input layer second column data, cₖ: input layer third column data, k: 1, 2, 3)

The output layer data of the machine learning model was 1×1 data (1 data).

In the simulation, the total number of input layer data=133×3×3, and the total number of output layer data=133. Input layer 1 chunk=9 data, output layer 1 chunk=1 data. One chunk is a group of data to be supplied to the input layer or the output layer in a learning process or an inference process (without learning) of one time.

In the learning process, data of 12 chunks of the input layer and 12 chunks of the output layer was learned for a total of 100 times (number of repeated learning iterations=99, learning of a total of 1200 chunks). In addition, in the inference process (without learning), 121 chunks of data of the input layer were inputted to the machine learning model after the above learning process, and 121 chunks of data were outputted.

Then, an error was calculated between the 133 data which are actual data of the output layer and the 133 data which are output layer data outputted during the learning process or the inference process, and the high accuracy was verified. For calculation of the error, the following Mean Squared Error (MSE) and Mean Squared Percentage Error (MSPE) were used.

$$MSE = \frac{1}{n} {\sum }_{i = 1}^{n} {( {y}_{i} - {\hat{y}}_{i} )}^{2} , MSPE = \frac{1}{n} {\sum }_{i = 1}^{n} \frac{{( {y}_{i} - {\hat{y}}_{i} )}^{2}}{{y}_{i}^{2}}$$

$$( \begin{matrix}{y}_{i} : actual output layer data \\ {\hat{y}}_{i} : predicted output layer data\end{matrix} )$$

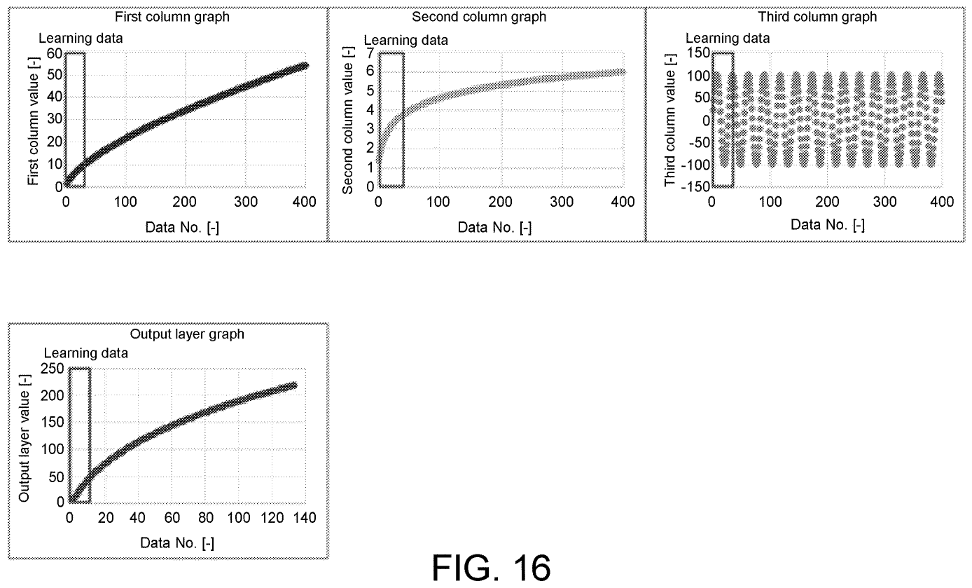

FIG. 16 shows the input layer data (three data in the upper part) and the output layer data (lower part) used in the simulation. The input layer first column data is expressed by a power function with data No. (1 to 399 (=133×3)) as a variable, the input layer second column data is expressed by a logarithmic function with data No. as a variable, and the input layer third column data is expressed by a trigonometric function with data No. as a variable. The output layer data y is expressed by the following equation.

y==a₁−2a₂+3a₃+(mean(b₁,b₂,b₃))³+(std(c₁,c₂,c₃))^{1/3}

The above output layer data y is used as teacher data during the learning process, and also used as actual output layer data when calculating errors. In FIG. 16, 12 chunks (=12× 3=36 data) of input layer data used as learning data are shown, and 12 chunks (=12 data) of output layer data used as learning data are shown.

### <<Regarding Simulation Conditions>

As simulation conditions, the learning process and the inference process were performed under the following seven simulation conditions, and the accuracy of prediction (values of errors) thereof was compared.

### Simulation Condition (1)

Number of hidden layer nodes: 5
Number of repeated learning iterations: 99
Computational precision: Bfloat16
Activation function: ReLU
Forgetting rate F: 1.000 fixed
Seed value: 49

The present simulation condition is a condition that suppresses divergence by fixing the forgetting rate of 1.000 and reducing the number of hidden layer nodes.

### Simulation Condition (2)

Number of hidden layer nodes: 5
Number of repeated learning iterations: 99
Computational precision: Bfloat16
Activation function: ReLU
Forgetting rate F: 1.002 fixed
Seed value: 49

The present simulation condition is a condition that further suppresses divergence by fixing the forgetting rate at a value greater than 1.00 and using the same number of hidden layer nodes as the simulation condition (1).

### Simulation Condition (3)

Number of hidden layer nodes: 5
Number of repeated learning iterations: 99
Computational precision: Bfloat16
Activation function: ReLU
Forgetting rate F: function F₁(x) with learning chunk number as argument
Seed value: 49

### Simulation Condition (3)′

Number of hidden layer nodes: 5
Number of repeated learning iterations: 99
Computational precision: Bfloat16
Activation function: ReLU
Forgetting rate F: function F₂(x) with learning chunk number as argument
Seed value: 49

The simulation conditions (3) and (3)′ are conditions that suppress divergence by setting the forgetting rate to a value greater than 1 only during chunk periods prone to divergence, and setting the forgetting rate to a value of 1 or less during other periods (the number of hidden layer nodes is the same as the simulation condition (1)).

### Simulation Condition (4)

Number of hidden layer nodes: 8
Number of repeated learning iterations: 99
Computational precision: Bfloat16
Activation function: ReLU
Forgetting rate F: 1.035 fixed
Seed value: 16

The present simulation condition is a condition in which the forgetting rate is fixed to a value greater than 1, and the number of hidden layer nodes is increased compared to the simulation condition (1).

### Simulation Condition (5)

Number of hidden layer nodes: 8
Number of repeated learning iterations: 99
Computational precision: Bfloat16
Activation function: ReLU
Forgetting rate F: function F₃(x) with learning chunk number as argument
Seed value: 16

### Simulation Condition (5)′

Number of hidden layer nodes: 8
Number of repeated learning iterations: 99
Computational precision: Bfloat16
Activation function: ReLU
Forgetting rate F: function F₄(x) with learning chunk number as argument
Seed value: 16

The simulation conditions (5) and (5)′ are conditions that suppress divergence by setting the forgetting rate to a value greater than 1 only during chunk periods prone to divergence, and setting the forgetting rate to a value of 1 or less during other periods (the number of hidden layer nodes is the same as the simulation condition (4)).

### <<Details of Forgetting Rate Function>

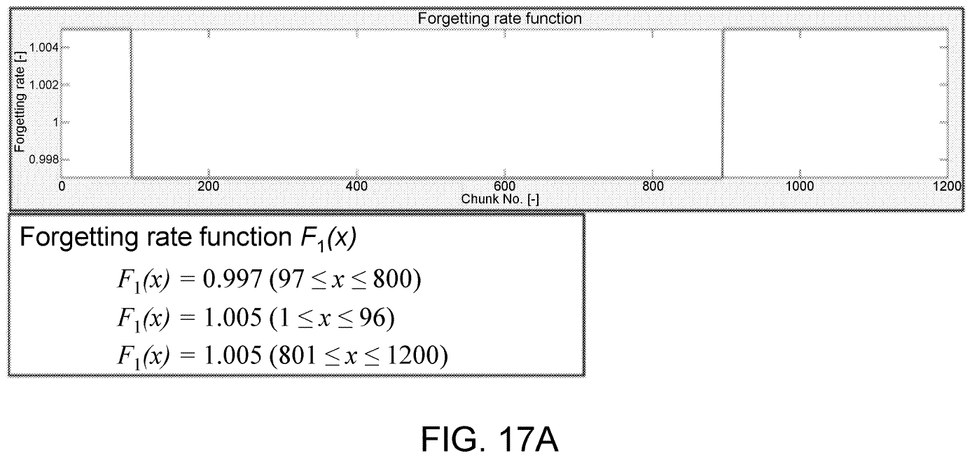

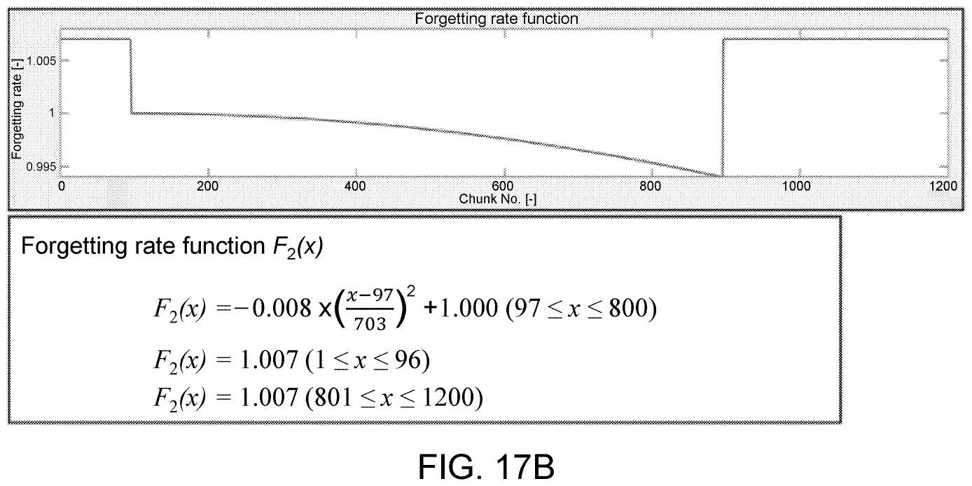

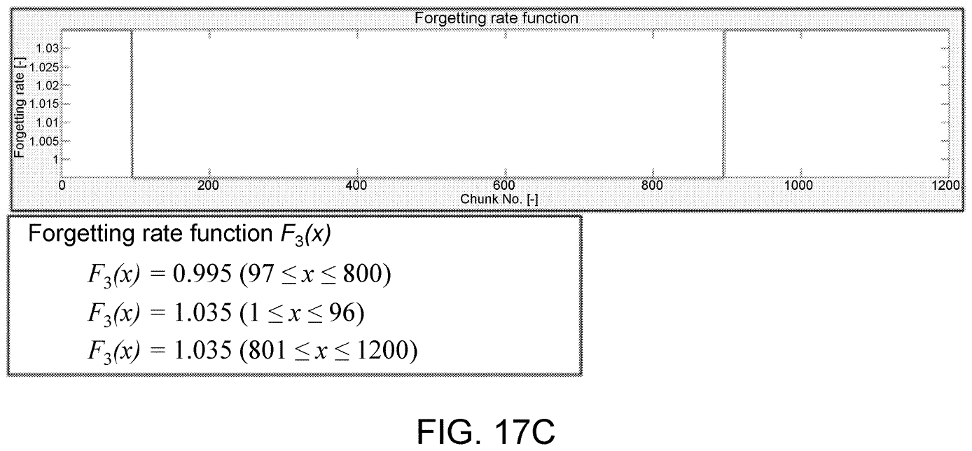

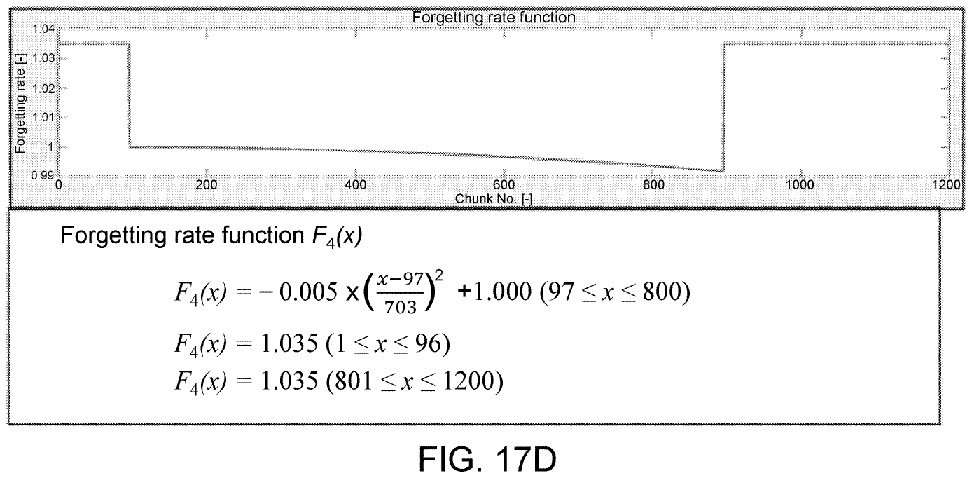

Details of the forgetting rate function F used in the simulation conditions (3), (3)′, (5), and (5)′ as described above will be described. FIG. 17A to FIG. 17D show the respective forgetting rate functions under the simulation conditions (3), (3)′, (5), and (5)′. In FIG. 17A to FIG. 17D, the horizontal axis represents chunk No. and the vertical axis represents the forgetting rate.

Since divergence is prone to occur during initial learning with the floating point precision Bfloat16, the forgetting rate is set to a value greater than 1 during initial learning (1st to 96th learning chunks in the simulation conditions (3), (3)′, (5), and (5)′) to suppress divergence.

As learning progresses to a certain extent, since divergence becomes less likely to occur even with the forgetting rate set to 1 or less, the forgetting rate is set to a value of 1 or less during an intermediate period of learning (97th to 800th learning chunks in the simulation conditions (3), (3)′, (5), and (5)′) to improve learning efficiency.

Although learning efficiency improves by continuing to set the forgetting rate to a value of 1 or less, there is a tendency for divergence to occur more easily. Therefore, during a final period of learning (801st to 1200th learning chunks in the simulation conditions (3), (3)′, (5), and (5)′), the forgetting rate is set to a value greater than 1 to suppress divergence again.

The forgetting rate functions F₁(x) and F₃(x) in the simulation conditions (3) and (5) are functions that maintain constant values during each of the initial learning period, the intermediate learning period, and the final learning period.

The forgetting rate functions F₂(x) and F₄(x) in the simulation conditions (3)′ and (5)′ maintain constant values during the initial learning period and the final learning period, and are power functions during the intermediate learning period. By setting a power function in the intermediate learning period, a period for further reducing the forgetting rate can be provided.

The forgetting rate function is not limited to the above, and may include, for example, any one of a monotonically increasing function, a monotonically decreasing function, a power function, a fractional function, a logarithmic function, an exponential function, a normal distribution function, or a trigonometric function, or a combination of multiple functions.

<<Comparison of Prediction Accuracy under Seven Simulation Conditions>>

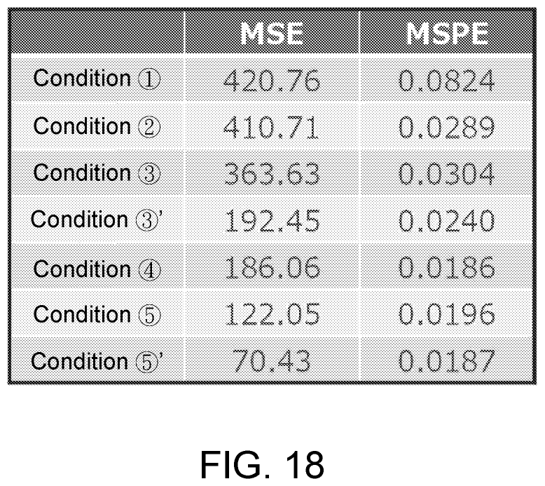

FIG. 18 shows the results of errors calculated under the seven conditions of the simulation conditions (1) to (5)′. As shown in the figure, for both error indices of MSE and MSPE, the values of errors become smaller sequentially from the simulation conditions (1) to (5)′, indicating that prediction accuracy becomes higher sequentially from the simulation conditions (1) to (5)′. Based on the comparison of the simulation conditions (1), (2), (3), and (3)′, it can be understood that even with the same number of hidden layer nodes, setting the forgetting rate to a value greater than 1 not only suppresses divergence but also improves prediction accuracy. In addition, even when the number of hidden layer nodes is increased as in the simulation conditions (4), (5), and (5)′, setting the forgetting rate to a value greater than 1 can suppress divergence while improving prediction accuracy.

### <Others>

The setting of the forgetting rate is not limited to the above, and for example, the rate of change between a loss after learning (calculated according to a loss function such as Equation (3) or Equation (4) above) and a previous one loss after learning may be calculated for each iteration, and the forgetting rate may be set to a value greater than 1 only in the case where the rate of change becomes large (such as the case where the rate of change exceeds a threshold) to suppress divergence.

### <Regarding Specific Conditions>

The update equation for the update matrix P in Equation (2) above is expressed as Equation (2A) below, with the batch size k=1 fixed.

$${P}_{i + 1} = {P}_{i} - \frac{{P}_{i} {H}_{i + 1}^{T} {H}_{i + 1} {P}_{i}}{1 + {H}_{i + 1} {P}_{i} {H}_{i + 1}^{T}} \qquad ( 2 A )$$

In the case where the calculation of 1/(1+Hᵢ₊₁PᵢHᵢ₊₁^{T}) in Equation (2A) above is not performed correctly, the inverse matrix calculation of Pᵢ₊₁ is not performed correctly, the updated weight β increases, and the loss also increases.

The specific conditions for Hᵢ₊₁PᵢHᵢ₊₁^{T} in the case where the calculation of 1/(1+Hᵢ₊₁PᵢHᵢ₊₁^{T}) is not performed correctly will be described below.

<<Specific Condition (1): The Absolute Value of 1+Hᵢ₊₁PᵢHᵢ₊₁^{T} is Sufficiently Large Compared to 1.>>

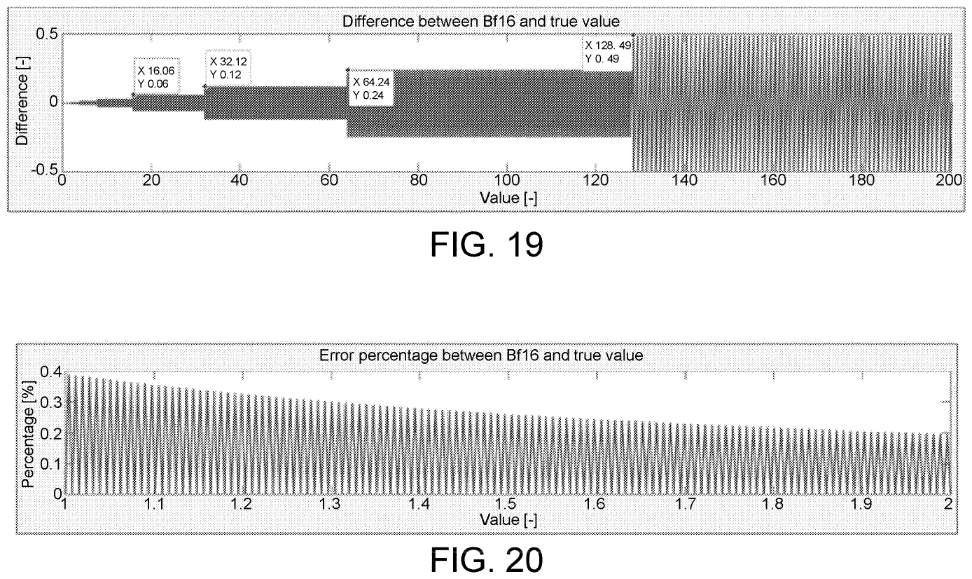

It is assumed that the learning calculation is performed in the floating point format Bfloat16. Bfloat16 is a floating point format with an 8-bit exponent part and a 7-bit mantissa part. Herein, FIG. 19 is a graph showing the relationship between true values (horizontal axis) from 0 to 200 with a step width of 0.01 and the difference between the true values and the values after Bfloat16 conversion. It can be understood that the maximum difference between the values after Bfloat16 conversion and the true values increases as the true values become greater by powers of 2.

In the case where the true value of 1+Hᵢ₊₁PᵢHᵢ₊₁^{T} is 128.49, for example, the value after Bfloat16 conversion becomes 1+Hᵢ₊₁PᵢHᵢ₊₁^{T}=128, resulting in a difference of as much as 0.49. Therefore, in the case where the absolute value of 1+Hᵢ₊₁PᵢHᵢ₊₁^{T} is sufficiently large compared to 1 (specific condition (1)), the error in the update of the update matrix P by Equation (2A) above becomes large, and the updated value cannot be calculated accurately. In this manner, the computational precision at the time of update of P deteriorates, leading to divergence of the weight β.

<<Specific condition (2): Hᵢ₊₁PᵢHᵢ₊₁^{T} is close to −1.>>

In the case where Hᵢ₊₁PᵢHᵢ₊₁^{T} is close to −1 (specific condition (2)), the value of 1/(1+Hᵢ₊₁PᵢHᵢ₊₁^{T}) becomes large, the update amount of the update matrix P becomes large according to Equation (2A) above, and Pᵢ, which is the learning result up to the previous time, is forgotten. Accordingly, the weight β cannot be updated correctly, and the loss increases. Such a phenomenon also occurs with the floating point format being, for example, Bfloat16 and double.

<<Specific Condition (3): The Absolute Value of Hᵢ₊₁PᵢHᵢ₊₁^{T} is Sufficiently Small Compared to 1.>>

Even in the case where the absolute value of Hᵢ₊₁PᵢHᵢ₊₁^{T} is sufficiently small compared to 1 (specific condition (3)), the update of the update matrix P is not performed well and the weight β is prone to divergence, which will be described below.

FIG. 20 is a graph showing the relationship between true values (horizontal axis) with a step width of 0.0001 in the range of 1 to 2, and the error percentage upon Bfloat16 conversion of the true values. The error percentage=abs (error)/true value*100. FIG. 20 shows the error percentage upon converting 1+Hᵢ₊₁PᵢHᵢ₊₁^{T} to Bfloat16 when the value of Hᵢ₊₁PᵢHᵢ₊₁^{T} is 0 to 1. It can be understood that the error increases as Hᵢ₊₁PᵢHᵢ₊₁^{T} approaches 0. If Hᵢ₊₁PᵢHᵢ₊₁^{T}=0.001, the numerical value upon converting 1+Hᵢ₊₁PᵢHᵢ₊₁^{T} to Bfloat16 becomes 1+Hᵢ₊₁PᵢHᵢ₊₁^{T}=1, with the information of 0.001 being completely eliminated. That is, in the case where Hᵢ₊₁PᵢHᵢ₊₁^{T} is sufficiently small compared to 1, the information of Hᵢ₊₁PᵢHᵢ₊₁^{T} is eliminated due to the resolution limit of Bfloat16.

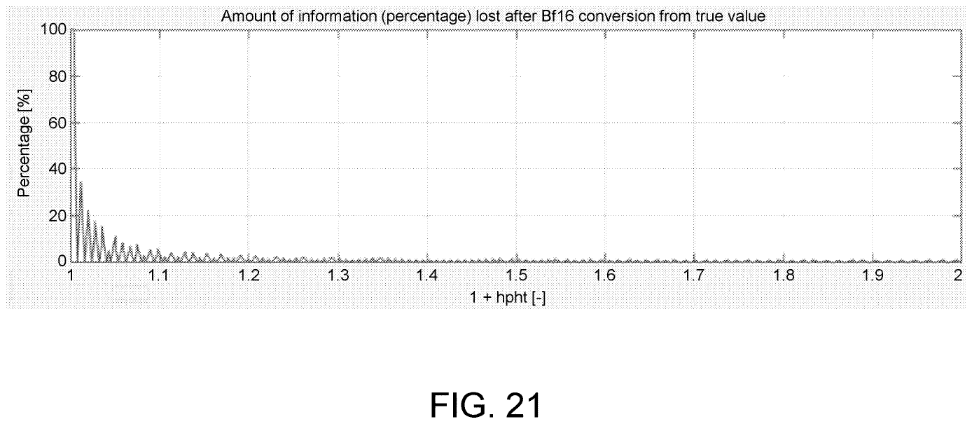

Herein, FIG. 21 shows how much information of Hᵢ₊₁PᵢHᵢ₊₁^{T} is eliminated as a percentage. It can be understood that in the case where Hᵢ₊₁PᵢHᵢ₊₁^{T} becomes 0.025 or less, there is a possibility that 10% or more of the information of Hᵢ₊₁PᵢHᵢ₋₁^{T} may be lost during Bfloat16 conversion.

### <Forgetting Rate Function>

If the forgetting rate F is controlled such that the forgetting rate F becomes large (specifically, greater than 1) under the specific conditions as described above, the weight β can be correctly updated, and divergence of the weight β can be suppressed. Such control of the forgetting rate F uses a forgetting rate function F(Hᵢ₊₁PᵢHᵢ₊₁^{T}), which is a function of the forgetting rate F with Hᵢ₊₁PᵢHᵢ₊₁^{T} as a variable. In the case of the forgetting rate F>1, the coefficient of the update amount of the weight β expressed by (1/F)² becomes smaller than 1.

Herein, the above specific conditions may be rephrased as follows.
Specific condition (1): The absolute value of 1+Hᵢ₊₁PᵢHᵢ₊₁^{T} is greater than a specific value.
Specific condition (2): Hᵢ₊₁PᵢHᵢ₊₁^{T} is in the vicinity of −1.
Specific condition (3): Hᵢ₊₁PᵢHᵢ₊₁^{T} is in the vicinity of 0.

Equation (5) below may be provided as an example of the forgetting rate function (the specific values in the equation are examples).

$$F ( {H}_{n + 1} {P}_{n} {H}_{n + 1}^{T} = A ) = {( 5000 * exp ( - {( \frac{A + 1}{0.25} )}^{2} ) + 2. * exp ( - {( \frac{A - 0.01}{0.05} )}^{2} ) + 5 * {10}^{- 5} * exp ( A - 20 ) + \frac{5 * {10}^{- 5}}{exp ( A + 20 )} + B )}^{1 / 2} \qquad ( 5 )$$

The first term of the target (within parentheses) for taking the square root (½ power) in the forgetting rate function, that is,

$$5000 * exp ( - {( \frac{A + 1}{0.25} )}^{2} ) ,$$

is a term for control under the specific condition (2).

The second term of the target (within parentheses) for taking the square root (½ power) in the forgetting rate function, that is,

$$2. * exp ( - {( \frac{A - 0.01}{0.05} )}^{2} ) ,$$

is a term for control under the specific condition (3).

The third term of the target (within parentheses) for taking the square root (½ power) in the forgetting rate function, that is,

$$5 * {10}^{- 5} * exp ( A - 20 ) + \frac{5 * {10}^{- 5}}{exp ( A + 20 )} ,$$

is a term for control under the specific condition (3).

B, which is the fourth term of the target (within parentheses) for taking the square root (½ power) in the forgetting rate function, exhibits an offset. The offset may be a constant value or may be a function controlled with the chunk No. as an argument.

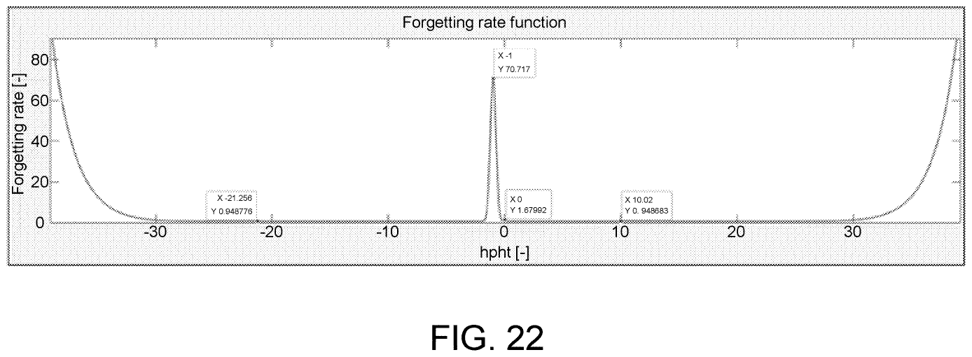

FIG. 22 is a graph showing the forgetting rate function expressed by Equation (5) above. The horizontal axis is Hᵢ₊₁PᵢHᵢ₊₁^{T}, and the vertical axis is the forgetting rate F. The case of offset B=0.9 is shown.

Regarding the specific condition (1), in the case where the absolute value of 1+Hᵢ₊₁PᵢHᵢ₊₁^{T} is greater than a constant value X, that is, in the case where 1+Hᵢ₊₁PᵢHᵢ₊₁^{T} is smaller than a threshold-X, or in the case where 1+Hᵢ₊₁PᵢHᵢ₊₁^{T} is greater than a threshold X, the forgetting rate is F>1. With the absolute value of 1+Hᵢ₊₁PᵢHᵢ₊₁^{T} being greater than 32 (X=32), the resolution of Bfloat16 deviates from the true value by 0.12 at maximum, resulting in a non-negligible error. Therefore, the forgetting rate F>1 is set in the case where Hᵢ₊₁PᵢHᵢ₊₁^{T} is greater than 31, or in the case where Hᵢ₊₁PᵢHᵢ₊₁^{T} is smaller than −33.

Regarding the specific condition (2), the range where Hᵢ₊₁PᵢHᵢ₊₁^{T} is in the vicinity of −1 is a range (first range) between a threshold Y1 (<−1) and a threshold Y2 (>−1), where Y1=−1.2 and Y2=−0.2. When Y1≤Hᵢ₊₁PᵢHᵢ₊₁^{T}<Y2, F>1. When Hᵢ₊₁PᵢHᵢ₊₁^{T}=−1, F takes the maximum value Fmax1 in the first range.

Regarding the specific condition (3), the range where Hᵢ₊₁PᵢHᵢ₊₁^{T} is in the vicinity of 0 is a range (second range) between a threshold Z1 (<0) and a threshold Z2 (>0), where Z1=−0.05 and Z2=0.05. When Z1≤Hᵢ₊₁PᵢHᵢ₊₁T<Z2, F>1. When Hᵢ₊₁PᵢHᵢ₊₁^{T}=0, F takes the maximum value Fmax2 in the second range.

Equation (5) above is expressed as a sum of exponential functions of Napier's constant e. In the case where Sigmoid is used as the activation function, particularly in the case where the machine learning device is mounted on an MCU, the exponential function of Napier's constant is a function that is easy to set. In addition, as a characteristic of exponential functions, exponential functions asymptotically approach 0 except under specific conditions, so the forgetting rate function can be expressed as one equation as a sum of terms that control the specific conditions.

The forgetting rate function is not limited to the format of Equation (5) above, and may be expressed using one, or combining two or more, of power functions, fractional functions, logarithmic functions, exponential functions, trigonometric functions, Sigmoid functions, normal distribution functions, step functions, and the like.

In addition, without being limited to using the forgetting rate function, the coefficient K of the update amount of the weight β may be a learning rate function K(Hᵢ₊₁PᵢHᵢ₊₁^{T}) that is controlled with Hᵢ₊₁PᵢHᵢ₊₁^{T} as a variable.

### Simulation Example of Learning Using Forgetting Rate Function

Herein, a simulation example of learning using the forgetting rate function will be described. The learning data is the same as the data (FIG. 5 and FIG. 6) used in “First Simulation Study” described above.

The common conditions of the simulation are as follows.

### Common Conditions:

Number of hidden layer nodes: 50
Computational precision: Bfloat16
Number of repeated learning iterations: 4 times
Activation function: ReLU
Loss function: MSE
Seed value: 6

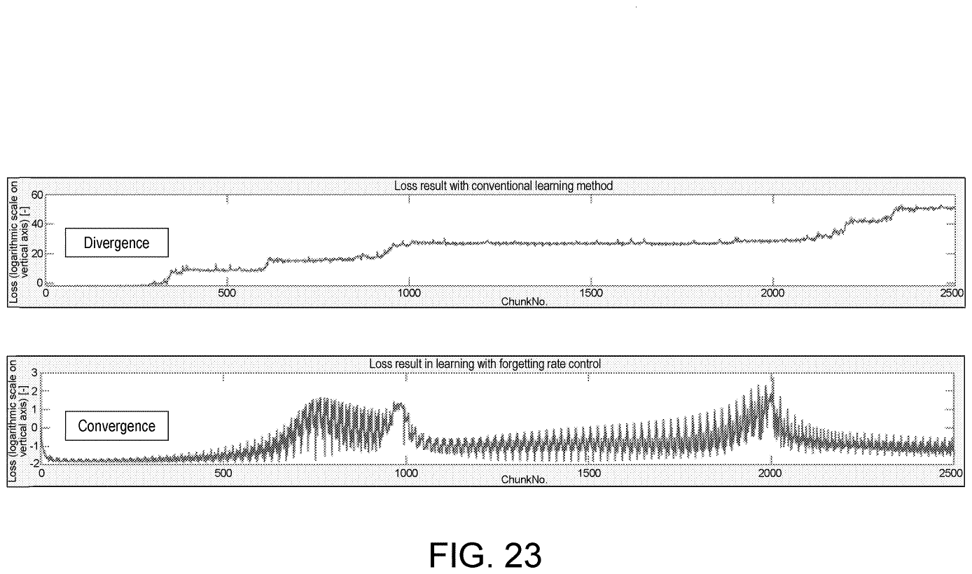

The upper part of FIG. 23 shows simulation results in the case of fixing the forgetting rate F=1 in addition to the above common conditions. FIG. 23 shows the transition of loss during learning for 4 repeated learning iterations, with the horizontal axis being chunk No. (chunk No. 1 to 2500 (=500×5) for 4 repeated learning iterations), and the vertical axis being loss shown logarithmically. On the other hand, the lower part of FIG. 23 shows simulation results in the case of implementing learning using a forgetting rate function in addition to the above common conditions. As shown in the figure, in the case of fixing the forgetting rate, the loss diverges, but by performing learning using a forgetting rate function, divergence of the loss is suppressed. Therefore, it can be understood that divergence of the weight β is suppressed.

### <Supplementary Notes>

As described above, a machine learning device (6) according to an aspect of the disclosure includes:
a model holding part (8) configured to hold a machine learning model (80) including an input layer (50A), an output layer (50C), and at least one intermediate layer (50B) disposed between the input layer and the output layer;
a learning calculation part (91) configured to execute a learning process of updating a weight (β) of the output layer in the machine learning model based on learning data, where
a coefficient of an update amount of the weight is capable of being set to a value smaller than 1 (first configuration).

According to such a configuration, by setting the coefficient of the update amount of the weight of the output layer to a value smaller than 1, the weighting of the update amount of the weight of the output layer can be reduced, thereby suppressing divergence of the weight of the output layer.

In addition, in the first configuration, the coefficient may be capable of being set to change between a value smaller than 1 and a value of 1 or more in the learning process (second configuration).

In addition, in the second configuration, a function in which a value of a parameter (e.g., forgetting rate F) for determining the coefficient changes with a learning iteration as an argument may be used (third configuration).

In addition, in the third configuration, the function may have any one of a monotonically increasing function, a monotonically decreasing function, a power function, a fractional function, a logarithmic function, an exponential function, a normal distribution function, a trigonometric function, or a combination of multiple functions (fourth configuration).

In addition, in any one of the first to fourth configurations, the coefficient may be expressed as a power of (1/F), with F being a forgetting rate (fifth configuration).

In addition, in the fifth configuration, the forgetting rate may be set to a value greater than 1 during an initial learning period (sixth configuration).

In addition, in the sixth configuration, the forgetting rate may be set to a value of 1 or less during at least any period after the initial learning period (seventh configuration).

In addition, in the seventh configuration, the forgetting rate may be set to a value of 1 or less during an intermediate learning period, and the forgetting rate may be set to a value greater than the value in the intermediate learning period during a final learning period (eighth configuration).

In addition, in the eighth configuration, the value of the forgetting rate may be set to be constant during each of the initial learning period, the intermediate learning period, and the final learning period (ninth configuration).

In addition, in the eighth configuration, the value of the forgetting rate may be constant during each of the initial learning period and the final learning period, and the value of the forgetting rate may be set to decrease from an initial value of 1 as learning progresses during the intermediate learning period (tenth configuration).

In addition, in any one of the first to tenth configurations, a computational precision of the learning process may be capable of being set by changing a floating point precision (eleventh configuration).

In addition, in the first or second configuration, a rate of change between a loss after learning and a previous one loss after learning may be calculated for each iteration, and the coefficient may be set to a value smaller than 1 only in the case where the rate of change becomes large (twelfth configuration).

In addition, in any one of the first to twelfth configurations, in the case where a specific parameter calculated in updating the weight during the learning process satisfies a specific condition that leads to poor update of the weight, the coefficient may be set to a value smaller than 1 (thirteenth configuration).

In addition, in the thirteenth configuration, in the learning process, the weight is sequentially updated based on equations below, and
in the case where Hᵢ₊₁PᵢHᵢ₊₁^{T} satisfies the specific condition, the coefficient represented by (1/F)² may be set to a value smaller than 1 (fourteenth configuration),

$${β}_{i + 1} = {β}_{i} + {( 1 / F )}^{2} * {P}_{i + 1} {H}_{i + 1}^{T} ( {t}_{i + 1} - {H}_{i + 1} {β}_{i} )$$

$${P}_{i + 1} = {P}_{i} - \frac{{P}_{i} {H}_{i + 1}^{T} {H}_{i + 1} {P}_{i}}{1 + {H}_{i + 1} {P}_{i} {H}_{i + 1}^{T}}$$

where x is input data to be inputted to the input layer, α is a weight from the input layer to the intermediate layer, β is the weight of the output layer, G is an activation function of the hidden layer, a hidden layer matrix H=G(x·α), P is an update matrix, and F is the forgetting rate.

In addition, in the fourteenth configuration, the specific condition may include a condition that an absolute value of 1+Hᵢ₊₁PᵢHᵢ₊₁^{T} is greater than a constant value (fifteenth configuration).

In addition, in the fifteenth configuration, a floating point format used for learning calculation may be Bfloat16 (sixteenth configuration).

In addition, in any one of the fourteenth to sixteenth configurations, the specific condition may include a condition that Hᵢ₊₁PᵢHᵢ₊₁^{T} is within a first predetermined range including −1 (seventeenth configuration).

In addition, in any one of the fourteenth to seventeenth configurations, the specific condition may include a condition that Hᵢ₊₁PᵢHᵢ₊₁^{T} is within a second predetermined range including 0 (eighteenth configuration).

In addition, in the eighteenth configuration, a floating point format used for learning calculation may be Bfloat16 (nineteenth configuration).

In addition, in any one of the fourteenth to nineteenth configurations, in the case where a forgetting rate function F(Hᵢ₊₁PᵢHᵢ₊₁^{T}) with Hᵢ₊₁PᵢHᵢ₊₁^{T} as a variable is used, and Hᵢ₊₁PᵢHᵢ₊₁^{T} satisfies the specific condition, the forgetting rate F may be controlled to be a value greater than 1 (twentieth configuration).

In addition, in the twentieth configuration, the forgetting rate function may include a term for controlling the forgetting rate under at least any one of the specific conditions among a first specific condition that an absolute value of 1+Hᵢ₊₁PᵢHᵢ₊₁^{T} is greater than a constant value, a second specific condition that Hᵢ₊₁PᵢHᵢ₊₁^{T} is within a first predetermined range including-1, and a third specific condition that Hᵢ₊₁PᵢHᵢ₊₁^{T} is within a second predetermined range including 0 (twenty-first configuration).

In addition, in the twenty-first configuration, the term may be expressed using an exponential function of Napier's constant (twenty-second configuration).

In addition, in the twenty-first or twenty-second configuration, the forgetting rate function may include a term of an offset (twenty-third configuration).

In addition, in the twenty-third configuration, with a set of learning data to be supplied to the machine learning model in learning for one time defined as a chunk, the offset may be expressed by a function taking a number of the chunk as a variable (twenty-fourth configuration).

In addition, an aspect of the present disclosure is a semiconductor device including a machine learning device having an integrated configuration of any one of the first to twenty-fourth configurations (twenty-fifth configuration).

In addition, an aspect of the present disclosure is a simulation program for functioning as a machine learning device having any one of the first to twenty-fourth configurations (twenty-sixth configuration).

The present disclosure may be used, for example, in simulation devices for AI model development, or semiconductor devices equipped with AI.

What is claimed is:

1. A machine learning device comprising:
a model holding part configured to hold a machine learning model including an input layer, an output layer, and at least one intermediate layer disposed between the input layer and the output layer; and
a learning calculation part configured to execute a learning process of updating a weight of the output layer in the machine learning model based on learning data, wherein
a coefficient of an update amount of the weight is capable of being set to a value smaller than 1.

2. The machine learning device according to claim 1, wherein
in the learning process, the coefficient is capable of being set to change between a value smaller than 1 and a value of 1 or more.

3. The machine learning device according to claim 2, wherein
the machine learning device uses a function in which a value of a parameter for determining the coefficient changes with a learning iteration as an argument.

4. The machine learning device according to claim 3, wherein
the function has any one of, or a combination of a plurality of: a monotonically increasing function, a monotonically decreasing function, a power function, a fractional function, a logarithmic function, an exponential function, a normal distribution function, and a trigonometric function.

5. The machine learning device according to claim 1, wherein
the coefficient is expressed by a power of (1/F), with F being a forgetting rate.

6. The machine learning device according to claim 5, wherein
the forgetting rate is set to a value greater than 1 during an initial learning period.

7. The machine learning device according to claim 6, wherein
the forgetting rate is set to a value of 1 or less during at least any period after the initial learning period.

8. The machine learning device according to claim 7, wherein
the forgetting rate is set to a value of 1 or less during an intermediate learning period, and the forgetting rate is set to a value greater than the value in the intermediate learning period during a final learning period.

9. The machine learning device according to claim 8, wherein
the value of the forgetting rate is set to be constant during each of the initial learning period, the intermediate learning period, and the final learning period.

10. The machine learning device according to claim 8, wherein
the value of the forgetting rate is constant during each of the initial learning period and the final learning period, and the value of the forgetting rate is set to decrease from an initial value of 1 as learning progresses during the intermediate learning period.

11. The machine learning device according to claim 1, wherein
a computational precision of the learning process is capable of being set by changing a floating point precision.

12. The machine learning device according to claim 1, wherein
a rate of change between a loss after learning and a previous one loss after learning is calculated for each iteration, and the coefficient is set to a value smaller than 1 only in a case where the rate of change becomes large.

13. The machine learning device according to claim 1, wherein
the coefficient is set to a value smaller than 1 in a case where a specific parameter calculated in updating the weight during the learning process satisfies a specific condition that leads to poor update of the weight.

14. The machine learning device according to claim 13, wherein
in the learning process, the weight is sequentially updated based on equations below, and
in a case where Hᵢ₊₁PᵢHᵢ₊₁^{T} satisfies the specific condition, the coefficient expressed by (1/F)² is set to a value smaller than 1,
$${β}_{i + 1} = {β}_{i} + {( 1 / F )}^{2} * {P}_{i + 1} {H}_{i + 1}^{T} ( {t}_{i + 1} - {H}_{i + 1} {β}_{i} )$$
$${P}_{i + 1} = {P}_{i} - \frac{{P}_{i} {H}_{i + 1}^{T} {H}_{i + 1} {P}_{i}}{1 + {H}_{i + 1} {P}_{i} {H}_{i + 1}^{T}}$$
where x is input data to be inputted to the input layer, α is a weight from the input layer to the intermediate layer, β is the weight of the output layer, G is an activation function of the intermediate layer, an intermediate layer matrix H=G(x·α), P is an update matrix, and F is a forgetting rate.

15. The machine learning device according to claim 14, wherein
the specific condition comprises a condition that an absolute value of 1+Hᵢ₊₁PᵢHᵢ₊₁^{T} is greater than a constant value.

16. The machine learning device according to claim 15, wherein
a floating point format used for learning calculation is Bfloat16.

17. The machine learning device according to claim 14, wherein
in a case where a forgetting rate function F(Hᵢ₊₁PᵢHᵢ₊₁^{T}) with Hᵢ₊₁PᵢHᵢ₊₁^{T} as a variable is used, and Hᵢ₊₁PᵢHᵢ₊₁^{T} satisfies the specific condition, the forgetting rate F is controlled to be a value greater than 1.

18. The machine learning device according to claim 17, wherein
the forgetting rate function comprises a term for controlling the forgetting rate under at least any one of the specific conditions among a first specific condition that an absolute value of 1+Hᵢ₊₁PᵢHᵢ₊₁^{T} is greater than a constant value, a second specific condition that Hᵢ₊₁PᵢHᵢ₊₁^{T} is within a first predetermined range including −1, and a third specific condition that Hᵢ₊₁PᵢHᵢ₊₁^{T} is within a second predetermined range including 0.

19. A semiconductor device comprising the machine learning device according to claim 1 which is integrated.

20. A non-transitory computer-readable recording medium recording a simulation program for functioning as the machine learning device according to claim 1.
